(19) United States
(12) Patent Application Publication
(10) Pub. No.: US 2018/0138556 A1
(43) Pub. Date: May 17, 2018

(54) Electrodes for faster charging in electrochemical systems

(71) Applicant: The Board of Trustees of the Leland Stanford Junior University, Palo Alto, CA (US)

(72) Inventors: James Palko, Merced, CA (US); Ali Hemmatifar, Stanford, CA (US); Juan G. Santiago, Stanford, CA (US)

(21) Appl. No.: 15/809,513

(22) Filed: Nov. 10, 2017

Related U.S. Application Data
(60) Provisional application No. 62/420,939, filed on Nov. 11, 2016.

(51) Int. Cl. H01M 10/42

(52) U.S. Cl. CPC H01M 10/4214; H01M 2004/021

(57) ABSTRACT

Improved charging performance for electrochemical devices such as batteries and supercapacitors is provided. A porous electrode is configured to have a lower electrode conductivity than the ion conductivity of the electrolyte disposed in pores of the electrode, in part or all of the electrode. This reduced electrode conductivity can be tailored to reduce ion depletion in the electrolyte. Modeling results show that the reduced ion depletion leads to decreased charging time. Further results show a negligible increase in total electrical loss, because increased loss in the electrode is compensated by reduced loss in the electrolyte. This approach is in sharp contrast to the conventional approach of simply maximizing electrode conductivity.

### CROSS REFERENCE TO RELATED APPLICATIONS

This application claims the benefit of U.S. provisional patent application 62/420,939, filed on Nov. 11, 2016, and hereby incorporated by reference in its entirety.

### FIELD OF THE INVENTION

This invention relates to porous electrodes for use in electrochemical and electrostatic energy storage devices.

### BACKGROUND

Electrochemical systems, including batteries and supercapacitors, are essential in energy storage. Such systems are commonly used in situations requiring the rapid storage of energy, including regenerative braking and time sensitive charging situations such as for hand tools and electric vehicles or for capacitive deionization (CDI) applications where throughput is key.

The distribution and transport of ions in electrolytes permeating porous electrodes often controls the performance of these devices. In particular, the local depletion of charge carrying ions can dramatically increase the resistance of the system, due to rapid ion removal from solution by the electrode, or due to ionic migration limitations under electric fields in the solution. This increase in local resistance can slow charging and discharging response of the system and may lead to high electric fields in the device, with consequences for failure modes such as dendrite growth.

### SUMMARY

Here, we consider the interplay between electronic conduction in the electrode matrix and ionic conduction in the pore space. By tailoring the spatial distribution of conductivity in the electrode matrix, we show the potential to control ionic concentration evolution in the pore space, and specifically to eliminate localized electrolyte depletion. This approach holds potential for improving time response of charging and discharging as well as enhancing reliability in electrochemical energy storage devices. We make use of the highly counterintuitive tactic of decreasing electrode conductivity (in a carefully tailored manner) while minimally affecting overall device efficiency.

Applications include but are not limited to: Energy storage for hybrid/electric vehicles, portable electronics, power tools, grid applications, water purification, and electrochemical processing.

Significant advantages are provided. The present approach suppresses the effect of electrolyte depletion which limits the high rate charging and discharging performance of many current systems. The present approach also reduces energy losses and capacity limitations associated with non-uniform charge distribution. The present approach also reduces electric fields associated with electrolyte depletion, which can promote detrimental electrochemical reactions. The result is to allow increased rates of charging and discharging for electrochemical systems such as electric double layer capacitors, capacitive deionization systems, and batteries.

FIG. 1A shows an exemplary embodiment of the invention. This example includes a porous electrode 102, a counter electrode 104, and an electrolyte medium 106 disposed to infiltrate pores of the porous electrode 102 and to fill a separation between the porous electrode 102 and the counter electrode 104, e.g. as shown. The electrolyte 106 is configured to conduct electric charge primarily by electromigration of ions. The porous electrode is configured to store and release the ions, thereby providing charge and discharge capability.

The porous electrode 102 is configured to conduct electric charge primarily by migration of electrons or holes. The effective electrode conductivity of the porous electrode is less than the effective ion conductivity of the porous electrode in part or all of the porous electrode, e.g. as schematically shown by plot 108.

Here the porosity of the porous electrode is defined as its volume fraction of pores. This quantity can vary within the porous electrode, so it is understood to be an average over a volume that is large compared to dimensions of a single pore and small compared to overall dimensions of the porous electrode.

Total current flow within the porous electrode has two components: 1) electrode current which is carried by electrons (or holes) moving within the porous electrode material, and 2) ion current carried by ions moving in the electrolyte disposed in the pores of the porous electrode.

The effective electrode conductivity (σₑ) is defined here as the (spatially varying) relation between local applied electric field and the effective electric current density in the porous electrode. Here effective electric current density is defined in terms of net electric current (i.e. current associated with flow of electrons and holes) and the full macroscopic cross section of the electrode normal to the direction of current flow. In simple cases, effective electrode conductivity can be approximated as σ_{elec} (1−p) where σ_{elec} is the conductivity of the fully dense electrode material itself and p is the porosity.

The effective ion conductivity (σᵢ) is defined as the spatially varying relation between applied electric field and ion current density in the porous electrode. Here current density is defined in terms of net ionic current and the full macroscopic cross section of the electrode normal to the direction of current flow. In simple cases, effective ion conductivity can be approximated as σᵢₒₙ*p where σᵢₒₙ is the conductivity of the fully dense electrolyte material and p is the porosity.

One example of the distribution of effective electrode conductivity (σₑ) in the porous electrode is one in which electrode conductivity is lower than the effective ion conductivity, (σᵢ), at locations in the porous electrode near the counter electrode and in which conductivity rises above that of the ionically conductive medium at positions within the porous electrode farther from the counter electrode, e.g., as shown by 108 on FIGS. 1A-B.

Another example of the distribution of effective electrode conductivity in the porous electrode, σₑ, is:

$${σ}_{e} = {σ}_{0} ( \frac{1}{( \frac{1.001 {L}_{e}}{x} - 1 )} + 0.001 )$$

where σ₀ is the effective conductivity of the porous electrode approximately at its midpoint in thickness, Lₑ is the thickness of the electrode along the direction of net current flow, and x is the spatial position in the first electrode along the direction of net current flow, with x=0 at the end of the electrode closest to the counter electrode. Another example of the distribution of effective electrode conductivity in the porous electrode is a piecewise constant function which increases as distance from the counter electrode increases. Another example is one in which the effective electrode conductivity in the porous electrode is uniform but lower than that of the ionically conductive medium.

The porous electrode can be formed from a mixture of powdered constituents. These constituents commonly include the active charge storing element functioning either by electrochemical reactions or electric double layer capacitance or both, a highly conductive component to increase resulting electrode conductivity (such as carbon black), and potentially a binder to improve mechanical properties. One method of decreasing conductivity of the electrode is inclusion of an insulating powdered component. One such candidate insulating component is silicon dioxide. The insulating component may partially or completely replace the highly conductive component allowing tailoring of electrode conductivity. Conductivity gradients may be produced in an electrode by layered deposition of the mixture of powdered constituents with the proportion of insulating and conducting constituents varied in each layer. Another method of decreasing the conductivity of the electrode is via coating of the electrochemically active particles with a layer of low conductivity material. The porous electrode can also be formed from a slurry of electrode material and the electrolyte medium.

As indicated above, the porous electrode is configured to store and release ions. Various physical mechanisms can provide this charging and discharging behavior, including but not limited to: double layer capacitance (e.g., as in supercapacitors) and electrochemical reactions (e.g., as in batteries).

In preferred embodiments, at least 10% by volume of the porous electrode has a lower effective electrode conductivity than effective ion conductivity. In more preferred embodiments, at least 40% by volume of the porous electrode has a lower effective electrode conductivity than effective ion conductivity.

Preferably the effective electrode conductivity of the porous electrode increases as distance from the counter electrode increases, as schematically shown by 108 on FIG. 1A.

FIG. 1B shows an embodiment where optional rectifiers 110 are connected in parallel with the porous electrode. Such rectifying behavior can helpfully reduce resistive losses during discharge, especially for fast discharge.

The effective electrode conductivity distribution of the porous electrode is preferably configured so as to control spatial distribution of charge storage in the electrode during charge and/or discharge of the electrode as well as spatial distribution of electrolyte concentration during charge and/or discharge. One example of the control of charge storage in the electrode is to produce a more uniform distribution of stored charge than that obtained with an electrode of uniformly higher conductivity. An example of the control of electrolyte concentration is to produce a more uniform distribution of electrolyte concentration during charging and/or discharging than that obtained with an electrode of uniformly higher conductivity. Another example of the control of electrolyte concentration is to retain high concentration of electrolyte at locations inside the porous electrode near the counter electrode during charging.

The effective electrode conductivity of the porous electrode can be configured to improve uniformity of stored charge in the porous electrode (e.g., as seen by comparing FIG. 7B to FIG. 3B). The effective electrode conductivity of the porous electrode can be configured to improve uniformity of concentration of the ions within the porous electrode (e.g., as seen by comparing FIG. 8A to FIG. 4A). The effective electrode conductivity of the porous electrode can be configured to enhance concentration of ions in solution in the electrolyte at locations inside the porous electrode near the counter electrode during charging of the apparatus (e.g., as seen by comparing FIG. 8A to FIG. 4A).

### BRIEF DESCRIPTION OF THE DRAWINGS

FIG. 1A shows an embodiment of the invention.

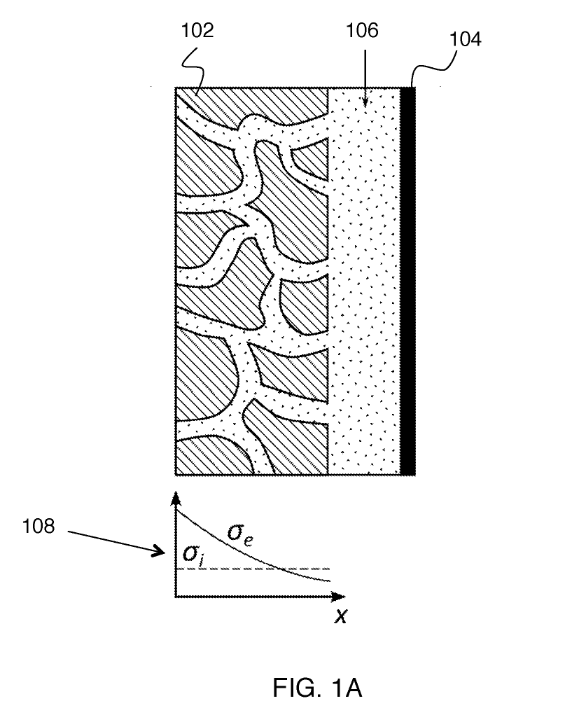

FIG. 1B shows another embodiment of the invention.

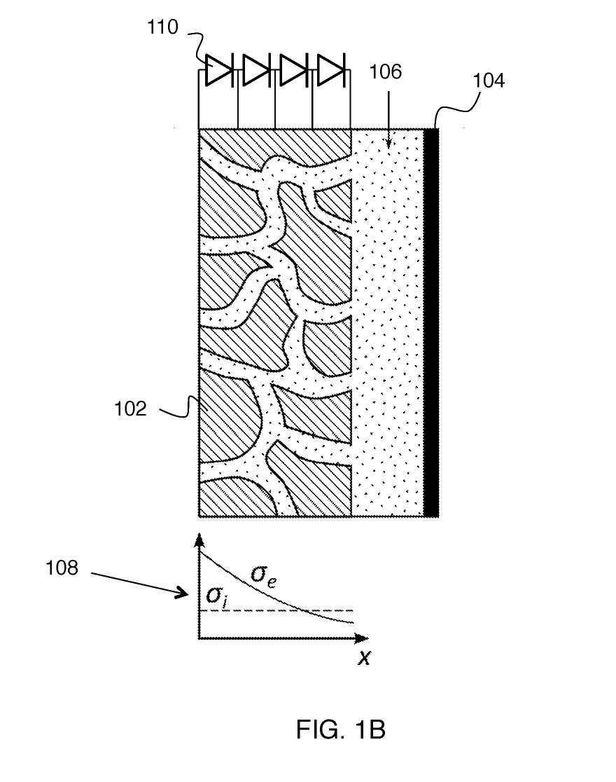

FIG. 2 shows a transmission line model of a supercapacitor.

FIGS. 3A-C show current flow and charging in an electrode with uniformly high conductivity.

FIGS. 4A-C show electrolyte depletion in an electrode with uniformly high conductivity.

FIGS. 5A-C show electrolyte depletion in an electrode with uniformly low conductivity.

FIG. 6 shows several electrode conductivity distributions considered in this work.

FIGS. 7A-C show current flow and charging in an electrode with a continuous varying conductivity distribution tailored to reduce electrolyte depletion.

FIGS. 8A-C show electrolyte depletion in an electrode with a continuous varying conductivity distribution tailored to reduce electrolyte depletion.

FIG. 9 shows conductivity vs. position and time for the piecewise constant conductivity distribution of FIG. 6.

FIG. 10 shows charge stored vs. time for the electrode conductivity distributions of FIG. 6.

FIG. 11A shows total resistive loss during charging for the electrode conductivity distributions of FIG. 6.

FIGS. 11B-E show the electrode and electrolyte contributions to loss for the electrode conductivity distributions of FIG. 6.

FIG. 12 shows total resistive loss during discharging for the electrode conductivity distributions of FIG. 6.

### DETAILED DESCRIPTION

This section provides a detailed example of application of the above-described principles in connection with modeling of a supercapacitor.

### A) Introduction

Electrochemical systems are commonly used in situations which strongly benefit from the rapid storage of energy, including time sensitive charging situations for electric vehicles, storage of short lived energy surges as in regenerative braking, and capacitive deionization (CDI) applications where increasing throughput is essential. System resistances, particularly series resistances, can have a strong impact on both charge/discharge time and dissipated energy. Constant voltage charging of a simple capacitor in series with a resistance provides a useful example. For fixed resistance, the charge stored by the capacitor asymptotically approaches a maximum value following an exponential dependence with a time constant equal to the product of series resistance and capacitance, τ=RC. Consequently, electrochemical system design has traditionally sought to reduce all sources of resistance, including solution resistance, electrode resistance, and in some cases, contact resistance between the electrodes and current collectors. Solution resistance generally dominates compared to resistance of electrode or current collector materials.

Supercapacitors are representative of electrochemical systems designed for fast charging and high power densities, and employ strategies to minimize series resistance. The thickness of spacer layers between the electrodes is minimized to reduce solution resistance for ion transport. Likewise, electrode thickness is minimized to reduce ion transport resistance through the depth of the porous electrode. Contact resistance between electrode and current collector is minimized by a variety of collector surface preparations and electrode deposition techniques. The standard design philosophy has been to maximize the conductivity of both current collectors and electrode materials. In this work, we show benefit to breaking with this design principle.

Local solution conductivity variations can also severely impact overall performance. As an electrochemical system is charged or discharged, ions are removed from or added to solution resulting in solution conductivities which evolve in time and space. Localized depletion of the electrolyte may significantly increase the net series resistance of the cell by introducing a choke point which limits charging rate. For example, electrolyte depletion can be important in a number of battery chemistries, such as Li-ion, operating at high currents and in supercapacitors. Likewise, the ability to deplete the working solution forms the basis of CDI. Significant depletion of electrolyte has a substantial effect on the charging response of the system.

Depletion depends on electrolyte concentration and the charge storage capacity of the electrode. The ultimate limit for electrolyte concentration is set by its solubility in the solvent, particularly at low operating temperatures, but other constraints often limit electrolyte concentrations further including cost and decreasing conductivity with further solute addition. Many electrochemical systems use solutions based on organic solvents in order to allow larger operating voltages with negligible electrolysis. Organic carbonates are popular solvent choices. Lithium hexafluorophosphate (LiPF₆) salt is the most commonly used electrolyte in Li-ion batteries while tetraethylammonium (TEA, (C₂H₅)₄N⁺) tetrafluoroborate (TFB, BF₄⁻) salt is commonly used for supercapacitors. Electrolyte concentrations are commonly limited to ˜1 mol/L.

Due to their high charge storage capacity, battery electrodes are usually capable of significant or complete local depletion of the electrolyte solution. This may be due to consumption of species in the electrochemical reaction (e.g. SO₄⁻ in lead-acid cell discharge) or electromigration of passive electrolyte species that do not participate in the reaction (e.g. PF₆⁻ in Li-ion cells). Commercial intercalation electrode materials for Li-ion batteries can show volumetric capacities that are many times the electrolyte concentration, exceeding 26 mol/L and 16 mol/L for cathodes and anodes, respectively, based on the total electrode volume. High volumetric capacities exacerbate electrolyte depletion. Newer materials under development show capacities that are dramatically higher still. Local electrolyte distribution has been measured directly during operation using magnetic resonance imaging in supercapacitors and lithium batteries.

Substantial depletion can also occur with current supercapacitor electrode materials, and the potential for depletion is compounded by recent advances in electrode materials, which have dramatically increased electrode capacitance and/or pseudo-capacitance along with energy storage capability. Specific capacitance of 160 F/g has been obtained in carbon aerogels treated to improve their hydrophobic character. Specific capacitance of 170 F/g has been obtained for aligned carbon nanotubes in acetonitrile with 1 mol/L TEA-TFB. A volumetric capacitance of 180 F/cm³ has been measured for thin (˜2 μm) films of carbide derived carbons in organic electrolytes. A specific pseudo-capacitance of 1020 F/g has been demonstrated in 1 mol/L LiClO₄/CH₃CN.

For a symmetric capacitor, the maximum total-volume-averaged (not local) change in concentration of ions in the pore volume is given by

$$Δ c = \frac{{CV}_{ma x}}{2 F ( 2 {p}_{e} + {p}_{s} {L}_{s} / {L}_{e} )} \qquad ( 1 )$$

where C is volumetric capacitance, Vₘₐₓ is the maximum cell voltage (split evenly in each electrode), F is Faraday's constant, pₑ is porosity of the electrodes, pₛ is the porosity of the spacer, and Lₑ and Lₛ are respectively thickness of electrodes and spacer. As an example, for specific capacitance of 250 F/g, apparent density of 0.4 g/cm³, porosity of 80%, Vₘₐₓ of 3 V, and Lₑ of 200 μm and Lₛ of 100 μm, the maximum concentration change (Δc) is 0.78 mol/L (i.e. 78% depletion of a standard 1 mol/L electrolyte). Newer pseudo capacitive materials would allow removal of electrolyte many times the solubility limit.

We note that the extremely large capacity of the electrodes for batteries, which provide volumetric storage of species rather than only the surface action of capacitive systems, further exacerbates localized depletion effects. Beyond the effect on charge/discharge rate, depletion has important consequences for battery lifetime and safety. Depletion has been implicated in the transition to dendritic Li growth and consequent shorting in cells with Li metal anodes.

In this work, we present what is to our knowledge a new design principle for electrochemical systems: The decrease and the tailoring of electrode conductivity to control and avoid local depletion of electrolytes. We begin with an introduction to our approach based on a transmission line circuit model describing the essential coupling of distributed electrolyte and electrode conductivities. We present a numerical model based on detailed porous electrode transport theory, and use this model to study spatiotemporal dynamics of electrolyte conductivity in the spacer and electrode pores. We then derive an analytical form of electrode conductivity for uniform salt adsorption and show how a tailored decrease in electrode conductivity can avoid local depletion and increase charging rate. Lastly, we show the effect of electrode conductivity on energy dissipation and the negligible effect of our tailored electrodes on overall resistive loss.

### B) Effect of Electrode Conductivity on Transport Dynamics

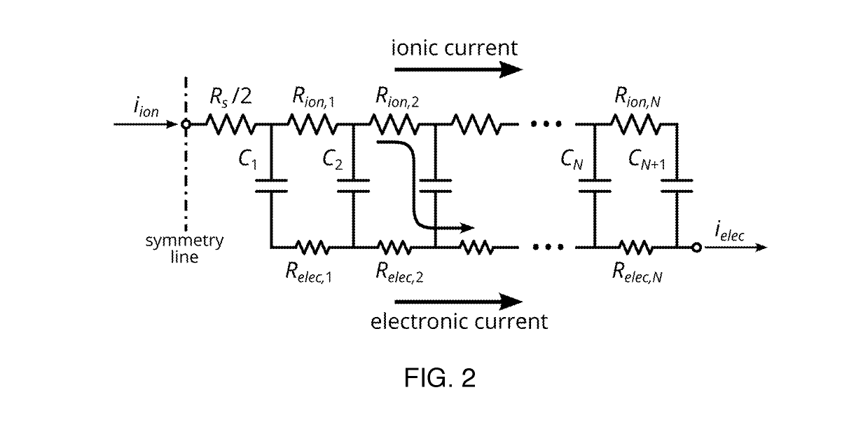

FIG. 2 is a transmission line model for a supercapacitor. The capacitor is symmetric about the indicated centerline on the left, with one electrode and half of the separator represented. Current enters as ionic flux from the left and flows as ionic current through solution, represented by resistors, R_{ion,i}. The ionic current flows through the pore space of the electrode and charges local capacitive elements, Cᵢ. The local capacitive elements can be interpreted as regions where ionic current is converted to electronic flux. Electronic current flows through the solid matrix of the electrode (R_{elec,i}), and total electronic current is collected at the terminal (node on bottom right). We here show that increasing values of R_{elec,i} and tailoring their spatial distribution can lead to more uniform charging of the electrochemical device (avoiding ion depletion in real systems).

We here introduce the effect of electrode conductivity on salt adsorption dynamics using a transmission line analogy. As we argued above, the specific spatial and temporal profile of ion removal from the electrolyte is intimately tied to the resistance and capacity of the rest of the electrochemical system. The response of these systems involves a complex interplay between electromigration and diffusive transport of electrolyte species throughout the porous structures of the electrodes and spacer. In FIG. 2, we show a useful schematic for study of temporal response and dissipation within a supercapacitor where each element represents a small thickness of the electrode or spacer. In response to an applied voltage, ionic current flows in the solution permeating the electrode and spacer, where it experiences non-uniform ionic resistances (R_{ion,i}) which depend on the local concentration of electrolyte. Electric double layers sequester ions from solution where they are balanced by electrons (or holes) in the electrode material, thus charging the local capacitive element (Cᵢ) and intimately coupling the ionic current to the electronic current. The electronic current flows through the electrode to the terminal. Typically, the resistances in the electrode are represented as uniform and negligibly small compared to the electrolyte resistance.

Indeed, as we have mentioned, electrochemical system designers often work to minimize all resistances including electrode materials, making the latter assumption accurate. To introduce our approach, we here consider appreciable and non-uniform electrode resistances R_{elec,i}. In traditional designs where R_{ion,i}>>R_{elec,i} for any location, the path of least resistance for the ionic current is to charge the nearest capacitive element (left-most element) favoring fast and near-spacer local conversion of ionic to electronic current that can escape to the terminal (lower right node) with minimal resistance. Under these conditions, charging of the electrode starts near the spacer and then proceeds into the depth of the electrode only when the capacitive elements near the spacer have been significantly charged. The depletion of the ions in solution will occur at the interface of the electrode and the spacer.

Depletion of ions accompanying charging of the electrodes can dramatically change the local solution resistance, and the resulting spatially non-uniform solution conductivity can have significant effects on the time response for charging of electrochemical systems including supercapacitors with high specific capacitance or low electrolyte concentrations. This effect has also been demonstrated at the pore scale. As we show here, improving uniformity of charging can largely eliminate ion depletion and improve the time response of these systems.

### C) Concept of Reduced and Non-Uniform Electrode Conductivity for Better Performance

We here consider how to improve the uniformity of charging by decreasing and tailoring the conductivity profile of the electrode. The principle is straightforward. First, we decrease the conductivity of the electrode near the spacer. This forces ionic current to penetrate deeper into the electrode before being converted to electronic current via charging of the electrode. Second, we use this principle to create a distribution of conductivities with makes charging approximately uniform, thus preventing depletion near the electrode/separator interface. As we shall show, this counterintuitive modification of decreasing electrode conductivity leads to notably improved charging time response with negligible effect on dissipated energy.

As we discuss in the next section, spatially uniform conversion of ionic to electronic current (e.g. coupling via displacement current through capacitive double layers) requires electrode conductivity similar in magnitude to the solution conductivity. Importantly, this decrease in electrode conductivity necessarily increases Ohmic losses in the electrode. However, we will show that this increased dissipation is approximately offset by the gain of avoiding Ohmic losses in the electrolyte associated with ion depletion. Hence, our approach of decreasing electrode conductivities can result in minimal overall energy penalties while substantially speeding up charging.

D) Porous Electrode Model Capturing a System with Non-Uniform Electrode Conductivity

We use macroscopic porous electrode (MPE) theory to model the behavior of supercapacitors during charging and discharging. To model the behavior of the framework we develop here, as an example and for simplicity, we consider a binary and symmetric electrolyte with equal anion and cation diffusion constants and equal electric mobilities. This assumption results in geometric symmetry about the midplane of the cell. We treat a one-dimensional model of the cell normal to the midplane. We also consider an isothermal system at 25° C. The framework presented here is general to asymmetric electrolytes and systems operating over a range of temperatures and under non-isothermal conditions.

Our formulation is based on MPE theory, meaning, transport equations are volume averaged. The volume averaging is performed over a scale substantially larger than pore features but small compared to the macroscopic size of the cell (in order to capture spatiotemporal variations of potential, concentration, etc.). The general form of the mass transport equation for species i in a porous electrode with fixed (in space and time) porosity p is

$$p \frac{\partial {c}_{i}}{\partial t} + p ∇ \cdot {j}_{i} = {s}_{i} , \qquad ( 2 )$$

where cᵢ is concentration of species i, jᵢ is its associated molar flux vector, and sᵢ is the local ion source term (a signed quantity, negative during charging). The molar flux vector jᵢ has convection, electromigration, and diffusion contributions and can be expressed as

jᵢ=ucᵢ−μᵢcᵢ∇ϕ−Dᵢ∇cᵢ, (3)

where u is local flow velocity, φ is electric potential, and Dᵢ and μᵢ are respectively tortuosity-corrected diffusivity and mobility of species i in the porous electrode. As an example, we have here used a simple correction for diffusivity and mobility using tortuosity as Dᵢ=τ⁻¹D_{i,∞} and μᵢ=τ⁻¹μ_{i,∞}, where τ is tortuosity and D_{i,∞} and μ_{i,∞} are respectively diffusivity and mobility of species i in free solution. Further, we relate tortuosity and porosity through the Bruggeman relation as τ=/p^{-1/2}. We assume electroneutrality holds in the spacer and electrode pores (far from electric double layers (EDLs)). So, for a binary and symmetric electrolyte, c₊=c₋=c. We model dynamics of the EDL structure with a simple Helmholtz model. This implies a constant and uniform EDL capacitance and unity charge efficiency. We further neglect bulk flow (u=0). These assumptions result in a simple mathematical model for the system, but do not reduce the generality of the approach. With these assumptions, we take a localized, small-volume average of the transport equations for anions and cations and arrive at the following forms for electrodes and spacer

$$\begin{matrix}{p}_{e} \frac{\partial c}{\partial t} - {p}_{e} {D}_{e} {∇}^{2} c = \frac{1}{2 F} \frac{\partial ρ}{\partial t} , ( electrodes ) & ( 4 ) \\ {p}_{s} \frac{\partial c}{\partial t} - {p}_{s} {D}_{s} {∇}^{2} c = 0 , ( spacer ) & ( 5 )\end{matrix}$$

where Pₑ and pₛ are respectively the porosity of electrodes and spacer. Similarly, Dₑ and Dₛ are tortuosity-corrected diffusivity of ions in electrodes and spacer. F is Faraday's constant, and ρ is stored charge density (in units of Coulombs per electrode volume). We further subtract transport equations for anions and cations and arrive at the current conservation equation in the electrode

$$\frac{\partial ρ}{\partial t} = {p}_{e} ∇ \cdot {i}_{ion} , \qquad ( 6 )$$

where iᵢₒₙ is the local ionic current density, within the electrolyte material itself. and can be written as iᵢₒₙ=σᵢₒₙ∇φ (Ohm's law) inside the electrodes, where σᵢₒₙ is conductivity of the fully dense electrolyte. We note that Ohm's law is valid for binary and symmetric electrolyte (where diffusive current vanishes). Similarly, ionic current density in the spacer is also given by iᵢₒₙ=σᵢₒₙ∇φ. As an example, we here use conductivity of a propylene carbonate solution of tetraethylammonium tetrafluoroborate (TEA-TFB) at 25° C. as reported in the literature. To this end, we first interpolate conductivity of free solution from the concentration-conductivity data (σ_{ion,‰}) and then correct it for tortuosity as σᵢₒₙ=τ⁻¹σ_{ion,∞} a using the Bruggeman relation.

The balance between ionic current density in the electrolyte (iᵢₒₙ), electronic current density in electrode matrix (i_{elec}), and external current can be written as

pₑiᵢₒₙ+(1−pₑ)i_{elec}=iₑₓₜ, (7)

where iₑₓₜ is the applied (external) current. Conservation of current in the spacer region (where no charge storage takes place) requires that the ionic current density is spatially uniform, i.e.,
∇·iᵢₒₙ=0. So, in the one-dimensional case, ionic current density in the spacer is simply

pₛiᵢₒₙ=iₑₓₜ.(spacer) (8)

We adopt a Helmholtz EDL model and relate electrolyte and electrode matrix potentials as

φ−φₑ=ρ/C, (9)

where φₑ is electrode matrix potential and C is specific capacitance for the EDL (in units of Farads per electrode volume). We note that current density in the electrode follows Ohm's law, i.e. i_{elec}=φ_{elec}∇φₑ, where σ_{elec} is electronic conductivity of the fully dense electrode material in the matrix. With these assumptions, we take divergence of eq 9 and combine it with eq 7 to express the current balance equation in terms of model variables c, iᵢₒₙ, and ρ as

$$( \frac{1}{{σ}_{ion}} + \frac{{p}_{e}}{( 1 - {p}_{e} ) {σ}_{elec}} ) {i}_{ion} = \frac{{i}_{ext}}{( 1 - {p}_{e} ) {σ}_{elec}} + \frac{1}{C} ∇ ρ . \\ ( electrode ) \qquad ( 10 )$$

We stress that eqs 8 and 10 describe ionic current density in the spacer and electrodes, respectively. In the case of known applied current (either constant or time-varying iₑₓₜ) the set of eqs 4-6, 8, and 10 fully describe charge/discharge dynamics of the cell. In the case where external voltage (and not external current) is known, however, we need to enforce an extra condition to ensure consistency between external current and the resulting voltage. To this end, we set solution potential to zero at the midplane of the cell (symmetry plane), integrate the electric field along the cell (from x=0 to x=Lₛ/2+Lₑ) and use the potential equation (φ−φₑ=ρ/C) to arrive at

$$\frac{{i}_{ext}}{{p}_{s}} {\int }_{0}^{{L}_{s} / 2} \frac{1}{{σ}_{ion}} dx + {\int }_{0}^{{L}_{s} / 2 + {L}_{e}} \frac{{i}_{ion}}{{σ}_{ion}} dx - \frac{{V}_{ext}}{2} = \frac{\text{?}}{C} \\ \text{?} \text{indicates text missing or illegible when filed} \qquad ( 11 )$$

where Vₑₓₜ is (constant or time-varying) external voltage, and \tilde{ρ} is stored charge density evaluated at the electrode-current collector interface. Note that eq 11, at any given time, is linear in iₑₓₜ and Vₑₓₜ, and so the formulation is reminiscent of Ohm's law for an ideal resistor.

Boundary and interface conditions used for the example model results shown here are as follows: (1) zero mass flux and ionic current at electrode-current collector interface, i.e. ∇c=0 and iᵢₒₙ=0, (2) symmetry in concentration, i.e. ∇c=0 at the midplane, (3) continuity of concentration and (4) continuity of mass flux (pₛDₛ∇c|ₛ=pₑDₑ∇c|ₑ) and ionic current (pₛiᵢₒₙ|ₛ=pₑiᵢₒₙ|e) at spacer-electrode interface.

We here show simulations of constant voltage charging, but note that high rate constant current charging shows similar effects. We implement this model in COMSOL Multiphysics (COMSOL Inc., Burlington, Mass.) using the equation-based modeling interface. We simulate a 10 cm² area cell with spacer thickness of 100 μm and electrode thickness of 200 μm (i.e., total cell thickness of 500 μm). Due to the symmetry of the model, we only solve for half of the cell. In all simulations, we consider electrode material with volumetric capacitance of 200 F/cm³ and porosity of 0.8 filled with electrolyte of 0.8 M TEA/TFB in propylene carbonate.

### E) Results and Discussion

E1) Electrolyte Depletion in an Electrode with Uniformly High Conductivity (Traditional Design)

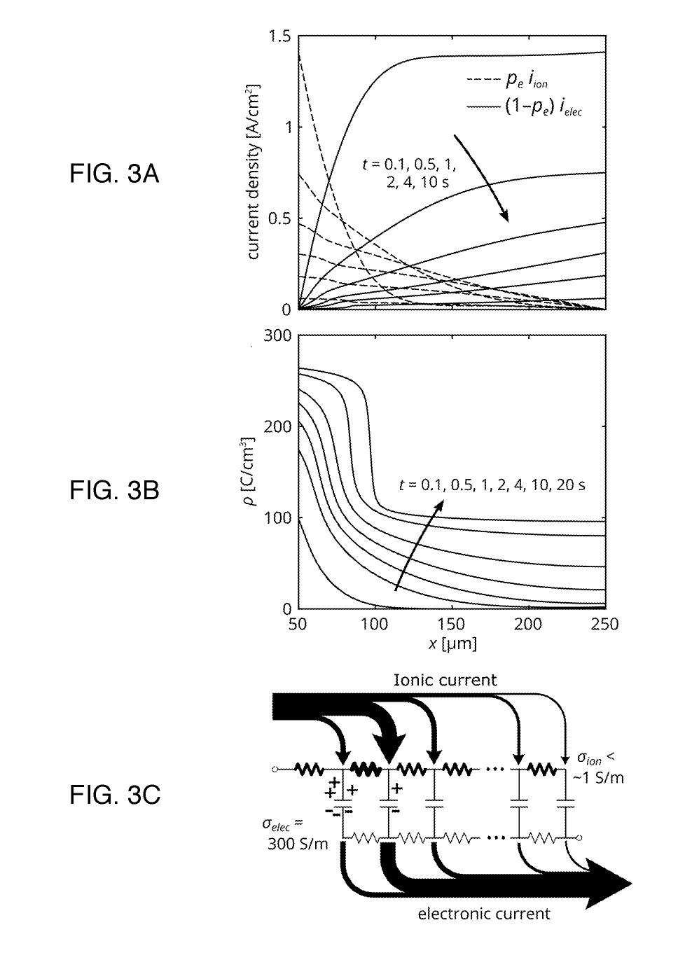

FIGS. 3A-C show current flow and charging in an electrode with high conductivity (i.e. σ_{elec}>>σᵢₒₙ) as in traditional porous electrode systems. FIG. 3A shows ionic current in pore space (dashed curves) and electronic current in electrode matrix (solid curves) versus position in a single electrode with high conductivity (σ_{elec}=300 S/m) at various times during constant voltage charging at 2.7 V. FIG. 3B shows density of charge accumulated in electrode versus position at various times. FIG. 3C shows schematic transmission line model for porous electrode. Ionic current entering from the spacer to the left converts to electronic current as soon as possible to take advantage of the high electrode matrix material conductivity (σ_{elec}=300 S/m) compared to the solution in pores (iᵢₒₙ<˜1 S/m). Consequently, the electrode is locally charged near the spacer. Only when the electrode acquires a significant charge and corresponding potential difference between electrode surface and solution, does the ionic current propagate deeper into the electrode.

The local spatial distribution of depletion depends strongly on the electrode conductivity. Common electrode materials traditionally have conductivities that are much higher than those of electrolyte solutions. The high conductivity of the electrode favors flow of electronic current in the electrode matrix rather than ionic current in the pore space. FIG. 3A shows the partition of current between the pore space and the electrode matrix as a function of depth in the electrode simulated for constant potential charging at a cell voltage of 2.7 V with an electrode matrix material conductivity (i.e. solid phase, not including porosity) of 300 S/m. This conductivity is representative of, for example, compacted activated carbon powder. The high conductivity of the electrode compared to the solution causes preferential charging of the electrode near the spacer interface (FIG. 3B). The lowest resistance path for current is conversion from ionic to electronic flux as early as possible, with charging of the “front” of the electrode near the spacer resulting, as shown schematically in FIG. 3C. Only when the electrode is highly charged locally and a significant local potential difference builds up between the electrode surface and solution, does the ionic current propagate deeper into the electrode.

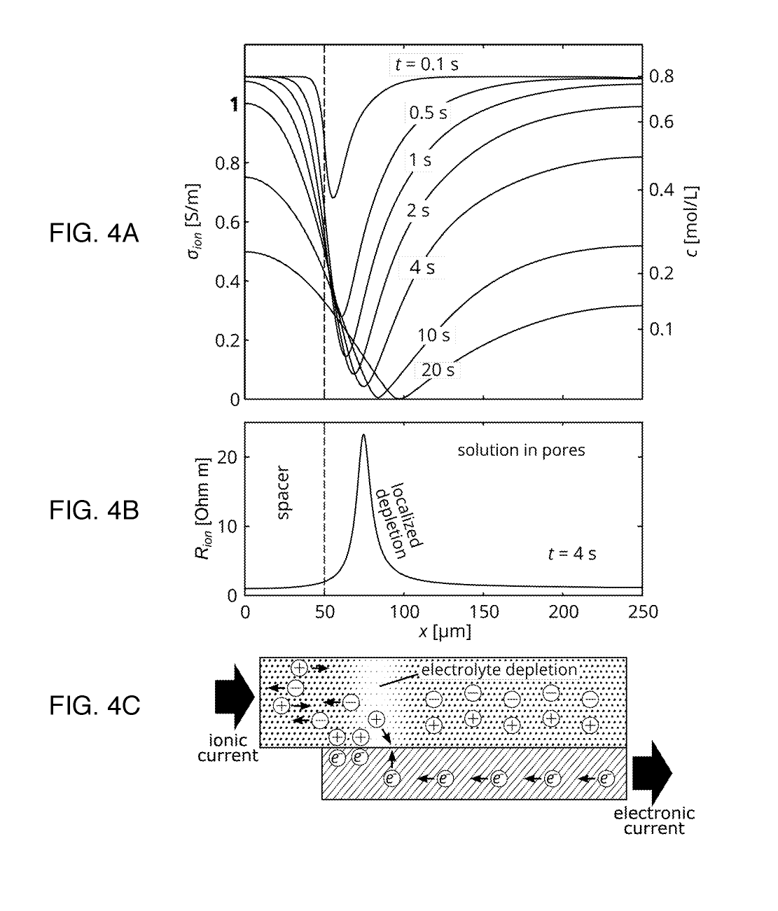

FIGS. 4A-C shows electrolyte depletion in an electrode with high matrix material conductivity (i.e. σ_{elec}>>σᵢₒₙ). FIG. 4A shows conductivity (left ordinate) and concentration (right ordinate) of electrolyte versus position in half of cell (symmetry line at x=0) at various times during constant voltage charging at 2.7 V for electrode with high conductivity (σ_{elec}=300 S/m). Vertical dashed line is the spacer-to-electrode interface. FIG. 4B shows solution resistivity profile for a single time showing localized depletion near spacer/electrode interface. FIG. 4C is a schematic of “front-to-back” charging. High electrode conductivity leads to localized charging near electrode/spacer interface. Resulting depletion creates a high resistance barrier that impedes ionic current. The electrode regions to the right of this barrier are high in electrolyte concentration but the electrolyte is isolated and “trapped” within the deeper regions of the electrode.

The charging at the spacer/electrode interface corresponds to localized depletion of the electrolyte in this region. FIG. 4A shows the effect of high electrode conductivity on depletion throughout the cell at various times. The non-uniform charging creates a “valley” in concentration and conductivity near the entrance of the electrode. The local volume depleted of electrolyte is a high resistance in series with the rest of the electrode as shown in FIG. 4B. The depletion region forms a high resistance barrier that impedes ionic current which must access the rest of the electrode, where electrolyte remains plentiful, to continue the charging process (FIG. 4C). The design strategy of maximizing electrode conductivity causes local depletion and a self-imposed starvation of the electrode.

### E2) Comparison Case of Low Electrode Conductivity (Also Resulting in Non-Uniform Charging)

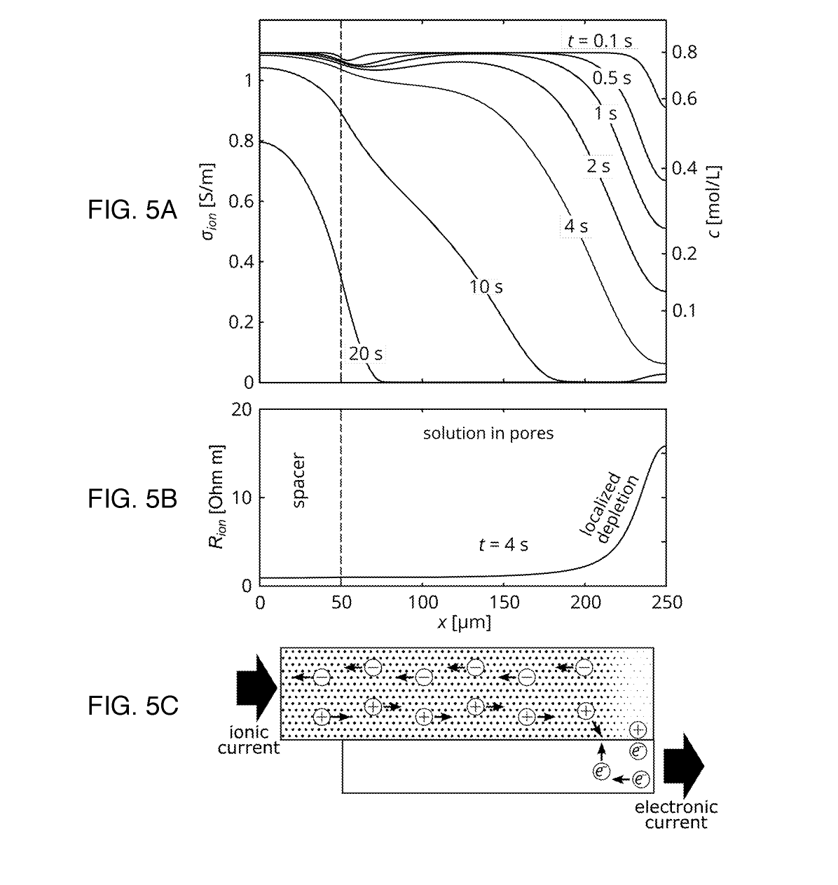

Before exploring optimal configurations of conductivity profiles, consider the useful comparison case of an electrode with conductivity uniformly lower than the initial electrolyte conductivity. We show model results for such a case in FIGS. 5A-C.

FIGS. 5A-C show electrolyte depletion in an electrode with uniformly very low conductivity (i.e. σ_{elec}<σᵢₒₙ). FIG. 5A shows conductivity (left ordinate) and concentration (right ordinate) of electrolyte versus position in half of cell at various times during constant voltage charging at 2.7 V for electrode with low conductivity (σ_{elec}=1 S/m). FIG. 5B shows solution resistivity profile for a single time showing localized depletion near electrode/current collector interface. FIG. 5C is a schematic of “back-to-front” charging. Low electrode conductivity leads to localized charging at the rear of the electrode near the electrode/current collector interface. Resulting depletion creates a high resistance region in the solution, but the ionic current never has to traverse this region. The electronic current in the matrix however experiences a uniformly high resistance.

Here, the path for ionic conduction through the electrode pore space offers lower resistance than electronic conduction through the electrode material. Ionic current is then driven through the electrode to the near-terminal region on the right (the “back” of the electrode” as in FIGS. 5A and 5C) before it is converted to electronic current by adsorption in the double layer (FIG. 5C). This extreme case results in a depletion region beginning at the rear of the electrode and growing with an interface moving toward the entrance (toward the left) as charging progresses. FIG. 5A shows solution conductivity and concentration versus depth within one electrode at various charging times for electrode conductivity 1 S/m, (compared to initial solution conductivity of 1.09 S/m). For this case, the ionic current never experiences a region of high resistance as it is always moving through less depleted regions with the depleted regions existing where charging has already completed (FIG. 5C). The electronic current, however, always experiences the now significant (overly high and uniform value of) resistance of the electrode.

E3) Electrode with Reduced and Non-Uniform Conductivity for Spatially Uniform Depletion

We here present a design of a porous electrode with non-uniform and decreased values of conductivity to achieve approximately uniform charging and electrolyte depletion. As we showed in FIGS. 3A-C, 4A-C and 5A-C, electrode conductivity is essential in governing the spatiotemporal response of the ionic current and the resulting depletion. Here we consider modifications to the electrode conductivity profile to achieve more uniform depletion throughout the electrode. It is important to note that exactly equal ionic and electrode conductivity does not lead to uniform depletion (this condition instead results in local depletion zones forming at the front and rear of the electrode, propagating rearward and frontward, respectively). A spatially varying electrode conductivity is required to produce spatially uniform depletion.

We consider this analytically from our porous electrode model capturing non-uniform electrode conductivity profiles. From eq 6, the local rate of depletion is proportional to the divergence of the ionic current at all points in the electrode. A uniform divergence of ionic current in the electrode (i.e. a linearly varying ionic current) implies a uniform rate of depletion at that instant in time. For uniform depletion rate in the volume-averaged one-dimensional model considered here, we need

$$\begin{matrix}∇ \cdot {i}_{ion} = constant & ( 12 ) \\ {i}_{ion} = \frac{1}{{p}_{e}} ( 1 - ξ ) {i}_{ext} & ( 13 )\end{matrix}$$

where ξ=(x−Lₛ/2)/Lₑ is a dimensionless parameter representing location (depth) into the electrode. (ξ=0 is at the electrode-solution interface, and ξ=1 is at the electrode/current-collector interface). Substituting eq 13 into eq 10, we derive a relationship between the required spatial dependence of electrode conductivity and solution conductivity to produce instantaneously uniform depletion

$$( 1 - {p}_{e} ) {σ}_{elec} = \frac{ξ}{\frac{1 - ξ}{{p}_{e} {σ}_{ion}} - \frac{∇ ρ}{{i}_{ext} C}} \qquad ( 14 )$$

Furthermore, considering a uniformly charged electrode state (∇ρ=0; e.g. ρ=0 everywhere), we can write

$${σ}_{elec} = \frac{ξ}{1 - ξ} \cdot \frac{{p}_{e}}{1 - {p}_{e}} {σ}_{ion} \qquad ( 15 )$$

For this state, there is no dependence on external current and the required electrode conductivity distribution depends only on the solution conductivity distribution via eq 15. To produce exactly uniform depletion over a finite time, the electrode conductivity must be time varying. However, as we show here, a time-invariant electrode conductivity distribution chosen to match the solution conductivity at a moderate level of depletion can provide a highly spatially uniform depletion rate over a large range of concentration change.

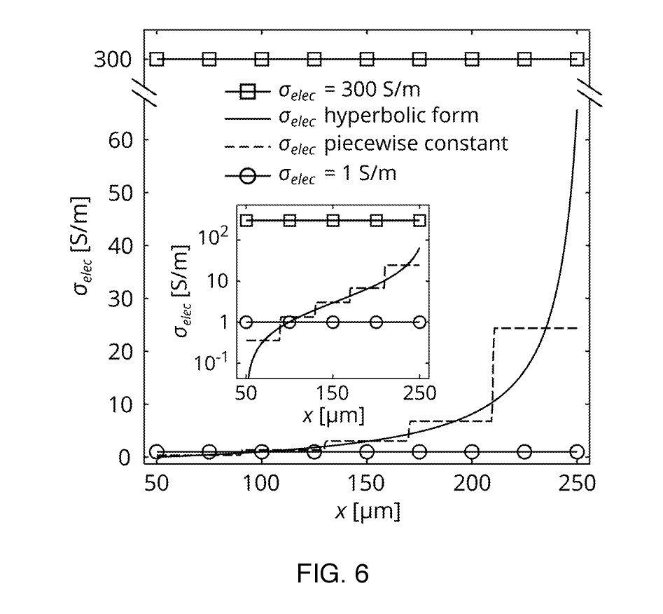

FIG. 6 shows electrode distributions considered here. First, we show uniformly high, traditional (squares) and uniformly low (circles) electrode conductivity. We also show two versions of a porous electrode with reduced and non-uniform electrode conductivities. The solid curve (without symbols) is an analytically derived function for the electrode conductivity distribution leading to uniform electrolyte removal. More specifically, this is given by eq 15 parameterized to produce a perfectly uniform depletion rate in our cell for a state corresponding to uniform charging and a uniform solution concentration of 0.445 mol/L (0.76 S/m). The conductivity distribution does not vary with time. We limited the conductivity of the electrode to 1.45 mS/m and 62 S/m at the front and back of the electrode, respectively, to avoid numerical instabilities due to excessively low or high conductivity.

The dashed lines are a simple discrete approximation of the solid curve having 5 segments with constant conductivity equal to the mean value of the continuously varying distribution at each segment midpoint (0.36, 1.33, 3.0, 6.8, and 24.4 S/m) for ease in manufacture. The inset displays conductivity on a logarithmic scale to more clearly show small changes in conductivity near the spacer.

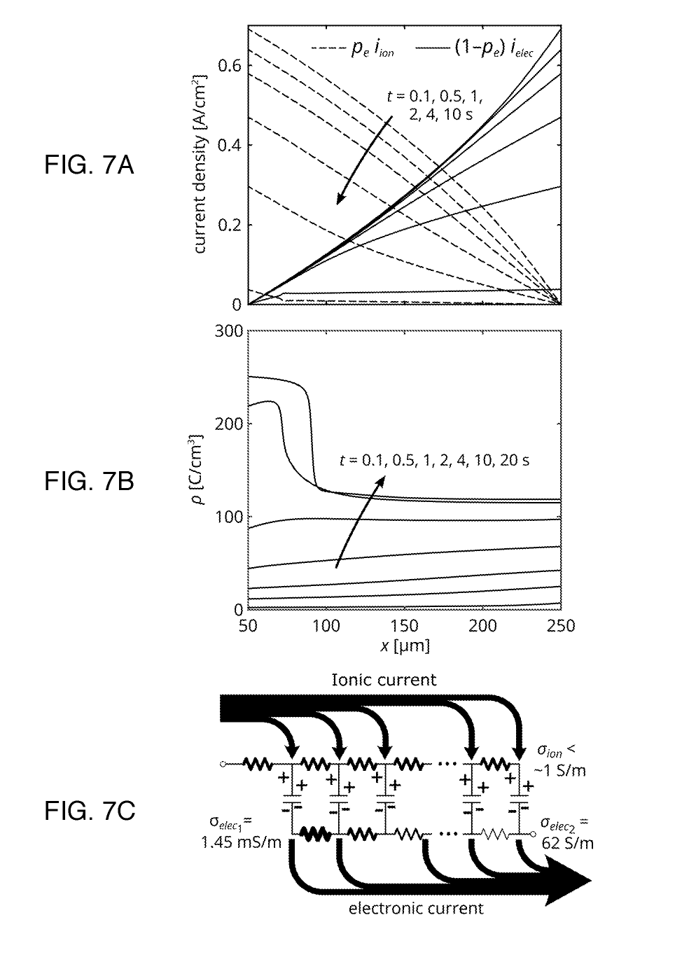

FIGS. 7A-C show current flow and charging in an electrode with tailored conductivity varying with position (eq. 15). FIG. 7A shows ionic current in pore space (dashed curves) and electronic current in electrode matrix (solid curves) versus position in a single electrode at various times during constant voltage charging at 2.7 V. Conversion of current from ionic flux in pores to electron flux in matrix occurs nearly uniformly across electrode leading to nearly linear current profiles (and nearly uniform divergence of current). FIG. 7B shows density of charge accumulated in electrode versus position at various times. Uniform divergence of current corresponds to highly uniform charging until late times. FIG. 7C is a schematic transmission line model for porous electrode with varying conductivity. Progressively increasing conductivity of electrode matrix with depth evenly distributes charging current.

FIGS. 7A-C show the spatiotemporal charging dynamics for our analytically derived reduced and non-uniform conductivity profile designed to charge the electrode more uniformly (and avoid local depletion zones). FIG. 7A shows that this conductivity profile results in nearly linear current distributions over a large range of times. The divergence of these current distributions is correspondingly quite uniform with position resulting in uniform charging of the electrode (FIG. 7A). The resulting charge distribution is significantly more uniform than either the high electrode conductivity (FIGS. 4A-C) or low electrode conductivity case (FIGS. 5A-C) over these times.

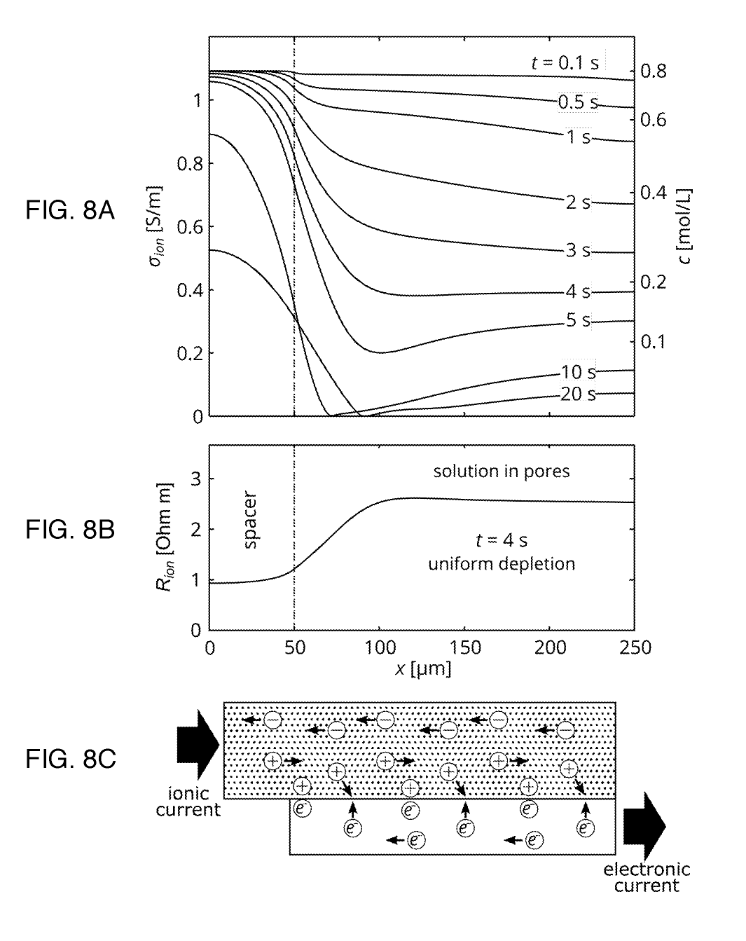

At later times (e.g. >10 s), charging becomes less uniform with preferential charging at the electrode/spacer interface. This effect is the result of essentially complete electrolyte depletion in the electrode, as shown below (FIGS. 8A-C).

The electrode conductivity distribution was parameterized to generate uniform removal rate from a solution with an instantaneous uniform conductivity of 0.76 S/m (0.45 mol/L concentration). The initial solution for this case is somewhat more conductive (1.09 S/m). Consequently, current paths leading to charging at the rear of the electrode are initially slightly favored, but the charging profiles remain quite uniform compared to the single valued (uniform) electrode conductivity cases. Between t=2s and 5s, the conductivity of the solution is sufficiently reduced that current paths leading to charging of the front of the electrode are then slightly favored resulting in a highly uniform state of charge at e.g. t=4 s.

FIG. 8A-C show electrolyte depletion for the continuously variable electrode conductivity shown in FIG. 6. FIG. 8A shows conductivity (left ordinate) and concentration (right ordinate) of electrolyte versus position in half of cell at various times during constant voltage charging at 2.7 V for electrode with low conductivity near the spacer (σ_{elec}=1.45 mS/m) and high conductivity near the current collector (σ_{elec}=62 S/m). FIG. 8B shows solution resistivity profile for a single time showing uniform and reduced depletion throughout the electrode. FIG. 8C is a schematic of uniform charging. Continuously increasing electrode matrix conductivity gradually converts ionic current entering from the spacer to the right into electronic current in the matrix and charges the electrode uniformly. The resulting uniform and reduced depletion prevents the creation of high resistance regions in the solution while also not unnecessarily impeding the electronic current in the electrode matrix.

The relatively uniform charging corresponds to uniform reduction in electrolyte concentration throughout the electrode as charging proceeds (FIG. 8A). This uniformity forestalls the formation of any high resistance regions in the solution permeating the pore space as seen in FIG. 8B. Ionic current is allowed to flow through the entire depth of the electrode without significant impediment (FIG. 8C).

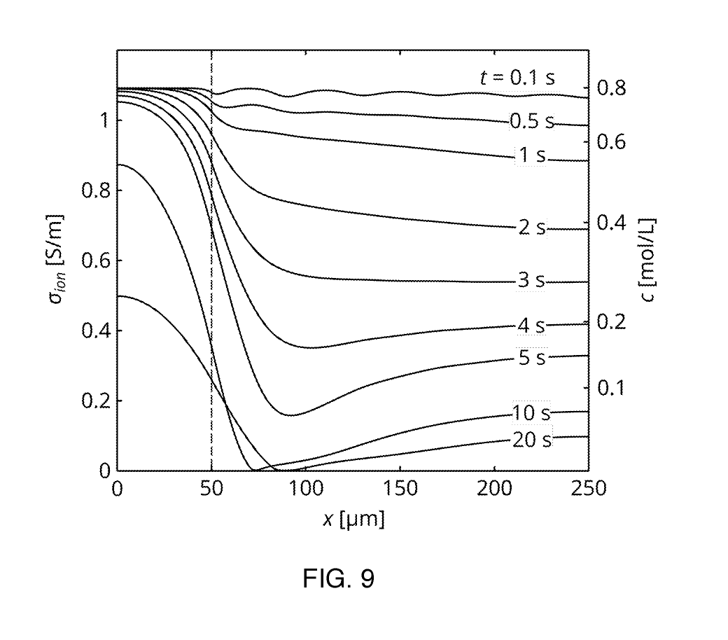

Diffusion of electrolyte in solution and the capacitive response of the electrode material both act to reduce spatial non-uniformities during depletion. As a result, a smooth electrode conductivity distribution is not required to produce highly uniform depletion. In FIG. 9 we show electrolyte depletion for an electrode with the piecewise constant, “stairstep” conductivity distribution shown in FIG. 6 and approximating the continuous distribution. At early times (<1 s), there are small spatial fluctuations in depletion corresponding to the abrupt variations in conductivity, but these rapidly decay to produce conductivity profiles indistinguishable from the electrode with smoothly varying conductivity. We expect the stepped conductivity profile to provide for significantly easier fabrication of the electrode.

In the next two sections, we will explore the effects of our approach for reduced and non-uniform electrode conductivity on charging time and energy consumption.

### E4) Effect of Electrode Conductivity Magnitude and Profile on Charging Time of System

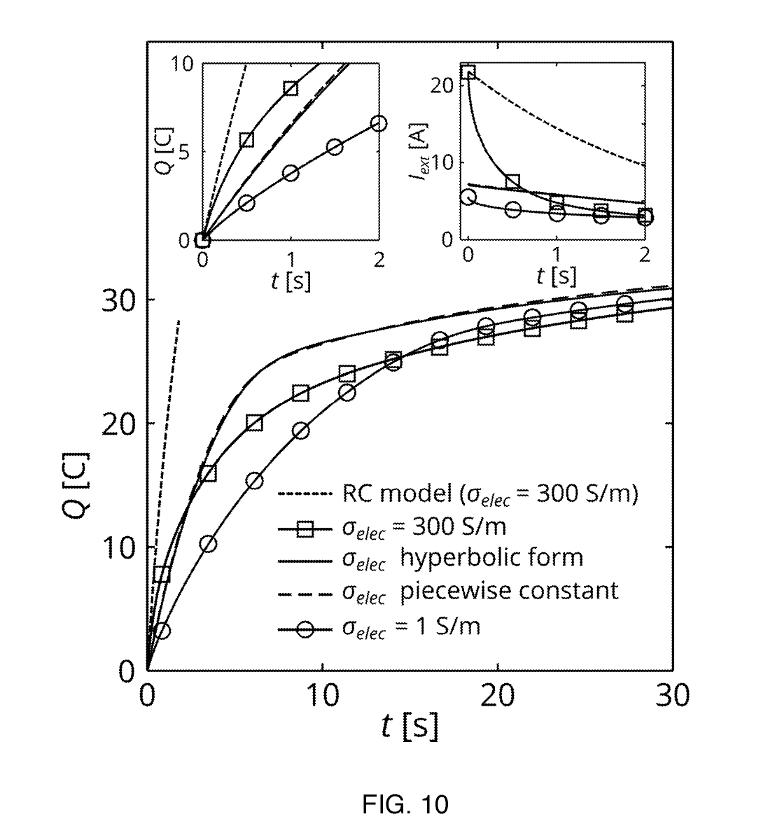

FIG. 10 shows charge stored versus time for all electrode conductivity cases considered here. Decrease of electrode conductivity decreases initial charging rates at very early times (top left inset), but uniform high conductivity electrodes can quickly develop depletion zones which subsequently strongly limit charging rate. The variable conductivity electrode designs avoid such depletions, and their charging rates quickly surpass the charging rate of the (traditional) uniform high conductivity case.

The resistance changes associated with depletion have a strong effect on the charging time response of the system. FIG. 10 shows the charge accumulated (Q) versus time for each of the electrode conductivity cases considered above (c.f. FIG. 6). Also, shown for reference is the ideal characteristic RC response based on the initial ionic resistance of the cell (R_{cell,0}) and a uniformly high conductivity electrode (dashed line). We formulate the latter characteristic response as

$$Q = {Q}_{RC} ( 1 - exp ( - t / {R}_{cell , 0} {C}_{cell} ) ) \approx \frac{{Q}_{RC}}{{R}_{cell , 0} {C}_{cell}} t , \qquad ( 16 )$$

where Q_{RC} is the maximum charge that could be stored based on the cell capacitance and applied voltage, neglecting any limit imposed by electrolyte concentration

Q_{RC}=C_{cell}V_{ext′} (17)

and C_{cell} is the total capacitance of the cell.

C_{cell}=CAₑLₑ/2 (18)

R_{cell,0} is then the equivalent resistance of the electrode for an uncharged state and given by

$${R}_{cell , 0} = 2 [ {\int }_{0}^{{L}_{s} / 2} \frac{dx}{{p}_{s} {A}_{e} {σ}_{ion} ( t = 0 )} + {\int }_{{L}_{s} / 2}^{{L}_{s} / 2 + {L}_{e}} \frac{dx}{{A}_{e} ( {p}_{e} {σ}_{ion} ( t = 0 ) + ( 1 - {p}_{e} ) {σ}_{elec} )} ] . \qquad ( 19 )$$

The first term in brackets is the ionic resistance of solution in the spacer, and the second term is ionic and electronic resistance in the porous electrode. This expression is readily apparent from examination of FIG. 2, considering all distributed capacitance elements as shorts at the first instant of charging. This resistance is representative of the value that is measured at high frequencies using electrochemical impedance spectroscopy and commonly reported as equivalent series resistance (ESR) in electric double layer capacitor specifications.

As can be seen in FIG. 10, the “traditional” high conductivity electrode configuration (solid line with squares) very rapidly deviates from the ideal RC response and exhibits a rapidly decreasing rate of charge due to depletion near the spacer (FIGS. 4A-C). In contrast, the low and uniform electrode conductivity case (solid line with circles) discussed in section E2 initially shows a much slower charging response than the uniform high conductivity case, since charging is here limited by the low electrode conductivity. Despite this, the low conductivity electrode charging rate decreases less abruptly than the high conductivity case as the ionic current has a less restricted path due to the localized depletion shifting to the back of the electrode. After about 15 s, charge storage on the low conductivity electrode surpasses that on the high conductivity electrode. The latter is an important point in that even uniformly low electrode conductivity can increase charging rate by avoiding depletion.

The continuously variable and piecewise constant electrode conductivity cases show nearly identical response to each other. Both variable electrode conductivity cases show somewhat slower initial charging rates than the high uniform electrode conductivity (traditional) case due to the increased electrode resistance, but they overtake the high uniform conductivity electrode within ˜2s. The variable electrode conductivity cases do not show significant decay in the charging rate until relatively high charge storage (˜25 C). The non-uniform profiles also show a much more abrupt change in charging rate than the other cases, which occurs after ˜7s. As seen from FIGS. 8A-C, this change is associated with near complete (and near uniform) depletion of the solution in the electrode itself. After this time, further charging requires diffusion of electrolyte into the electrode from the spacer which occurs at slow rates. Notably, decreasing the initial conductivity of the electrode increases overall charging rate counter to traditional approaches which attempt to minimize all sources of resistance based on the ideal RC model for capacitors.

### E5) Effect of Electrode Conductivity Magnitude and Profile on Energy Loss

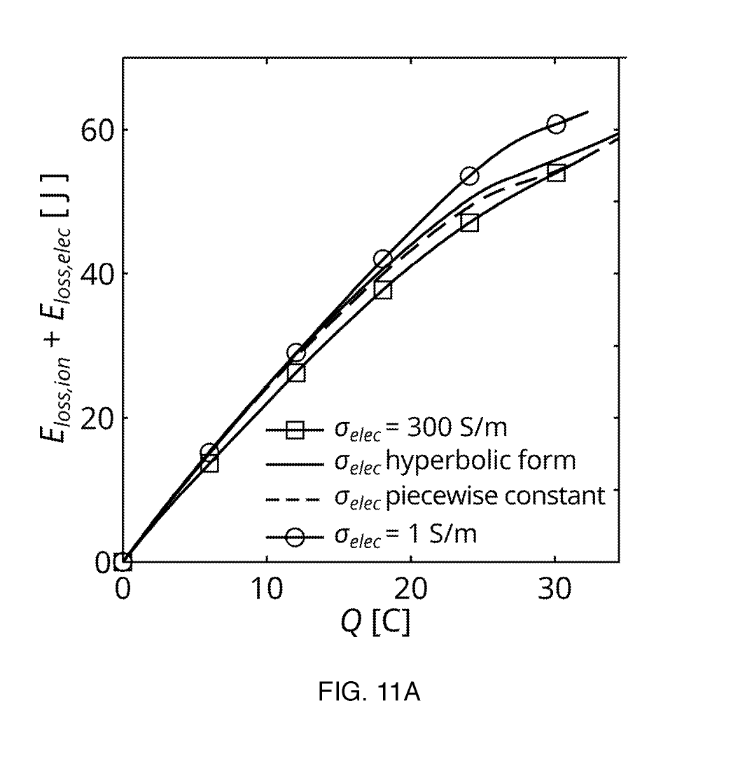

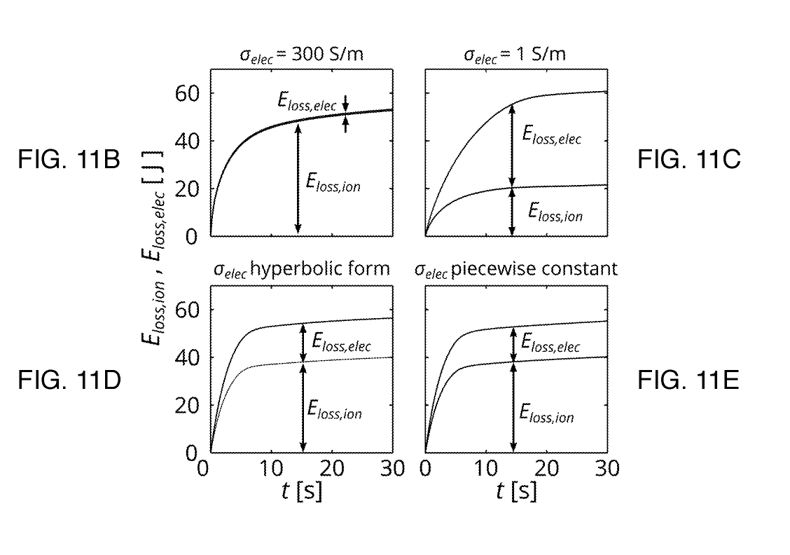

In traditional systems, most of the energy loss in the electrode region is due to low conductivity of the electrolyte (compared to the electrode). Hence, it is important to explore the effect of decreasing electrode conductivity to achieve more uniform and faster charging. FIGS. 11A-E show cumulative resistive energy loss during charging at 2.7 V for the various electrode designs explored. FIG. 11A shows total cumulative resistive loss for each of the four electrode conductivity cases versus stored charge. The (traditional) high conductivity electrode (σ_{elec}=300 S/m) shows lowest total loss, but the non-uniform and lower conductivity electrodes (σ_{elec}=1.45 to 62 S/m) show <5% additional loss. The spatially uniform, lower conductivity electrode (σ_{elec}=1 S/m) shows <15% additional loss. FIGS. 11B-E show electrode, E_{loss,elec}, and solution, E_{loss,ion}, energy loss contributions to cumulative resistive energy loss as a function of time for (FIG. 11B) high conductivity electrode, (FIG. 11C) spatially uniform lower conductivity electrode, (FIG. 11D) continuously spatially variable lower conductivity electrode, and (FIG. 11E) stepwise spatially variable lower conductivity electrode. Increases in electrode resistive losses are largely offset by decreased solution resistive losses resulting from the decreased effect of localized depletion.

FIGS. 11A-E show plots of cumulative resistive energy loss during potentiostatic charging at 2.7 V for each of the four electrode conductivity cases of FIG. 6. FIG. 11A shows total cumulative resistive loss versus stored charge. The high conductivity electrode shows the lowest loss. However, the variable conductivity electrodes show only slightly higher losses. For example, for the cases we explored, variable conductivity electrode energy losses never exceed 5% additional loss compared to the high conductivity case and return close to the high conductivity loss value at the highest stored charges where depletion is most severe. The low conductivity electrode shows the highest loss, but still <15% greater than the high conductivity case despite having an initial characteristic cell resistance which is ˜100% larger. FIG. 11B shows the contributions of the solution, E_{loss,ion}, and electrode, E_{loss,elec}, to resistive loss versus time, as given by

$$\begin{matrix}{E}_{loss , ion} ( t ) = 2 {A}_{e} {\int }_{0}^{t} [ {p}_{s} {\int }_{0}^{{L}_{s} / 2} \frac{{i}_{ion}^{2}}{{σ}_{ion}} dx + {p}_{e} {\int }_{{L}_{s} / 2}^{{L}_{s} / 2 + {L}_{e}} \frac{{i}_{ion}^{2}}{{σ}_{ion}} dx ] {dt}^{′} & ( 20 ) \\ {E}_{loss , elec} ( t ) = 2 {A}_{e} ( 1 - {p}_{e} ) {\int }_{0}^{t} {\int }_{{L}_{s} / 2}^{{L}_{s} / 2 + {L}_{e}} \frac{{i}_{elec}^{2}}{{σ}_{elec}} {dxdt}^{′} & ( 21 )\end{matrix}$$

The high conductivity electrode energy dissipation is dominated by solution loss since the resistance of the electrode is minimal. All electrodes with decreased conductivity show higher electrode losses as expected, but also show significantly reduced solution resistance losses compared to the high conductivity electrode due to the suppression of depletion at the electrode-spacer interface. The net effect is a minimal increase in resistive losses for electrodes with decreased conductivity (e.g. as discussed above, <5% increase in energy loss for variable conductivity electrodes).

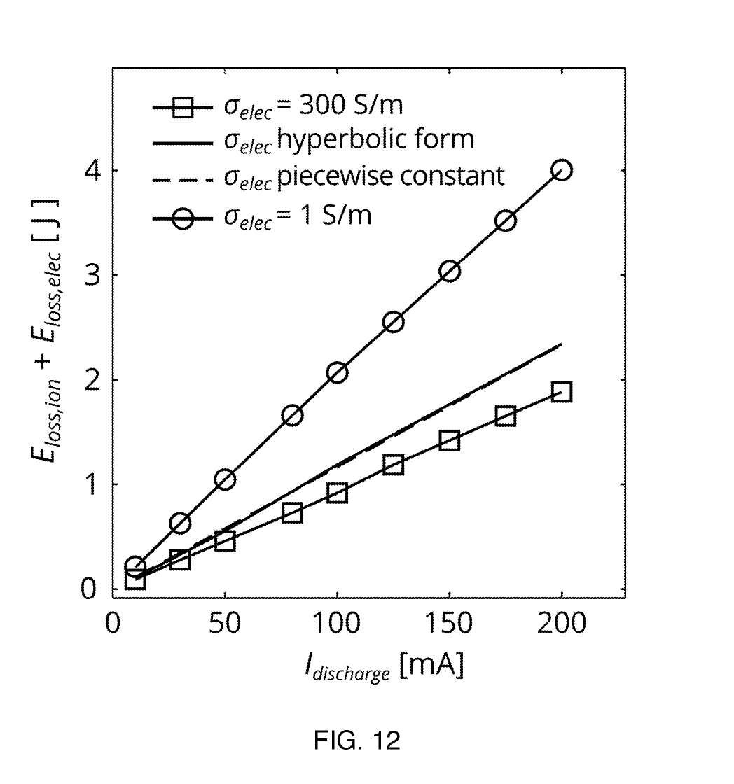

During discharge, for the supercapacitor example considered, electrolyte concentration and solution conductivity increase. We expect control of the release of ions to have a much smaller effect on discharge energy loss than electrolyte depletion during charging and for electrodes with lower conductivity to show larger losses in discharge. However, the total loss depends on the rate of discharge. FIG. 12 shows resistive energy loss for complete galvanostatic discharge from 30 C charge versus discharge rate for all electrode conductivity cases. Reduced electrode conductivity corresponds to greater dissipation, but loss during discharge is strongly mitigated by slower discharge rates.

As expected, the electrodes with decreased conductivity show greater loss compared to the uniform high conductivity case. However, as discharge rate is decreased (lower discharge current), the additional energy loss during discharge becomes negligibly small. For comparison, with the cell considered, discharge times of about 2.3, 10, and 50 min (200, 50, and 10 mA discharge currents) correspond to 4.6×, 20× and 100× slower discharge rates, respectively, compared to the constant voltage charging time of about 30 s (see FIG. 10). At these rates, energy losses on discharge for the continuously spatially varying conductivity electrode (solid line in FIG. 12), are only 8%, 2%, and 0.4% of energy loss at charging, respectively. We also note that a number of battery chemistries (e.g. Li-ion, Pb-acid) experience electrolyte depletion on discharge as well. In these cases, high rate discharge may likewise benefit from the tailoring of electrode resistance.

Furthermore, the electrode conductivity need not be symmetric on charge and discharge. For example the addition of a rectifying capability in the electrode could largely remove the additional loss on discharge and reduce discharge time constant while retaining the desired resistivity gradients during charge.

### F) Conclusions

Depletion of electrolyte in electrochemical systems can have dramatic effects on their charging time responses and contribute to energy loss as well as system lifetime reduction. Maximization of electrode conductivity, as in traditional porous electrodes, can minimize energy loss, but also promotes highly localized depletion and electrolyte starvation of the electrode. We here provide a new approach wherein we reduce and control the distribution of porous electrode conductivity as a means to avoid ion depletion and achieve highly uniform charging of the electrode. This can be used to improve charging response of electrochemical systems such as supercapacitors via the counterintuitive approach of increasing electrode resistance.

We presented a transmission line analogy useful in describing the principle of spatially non-uniform resistance electrodes to achieve uniform charging. Further, we developed a porous electrode theory transport model which captures the effect of electrode conductivity magnitude and distributions. We use this model to show that spatially tailoring of the electrode conductivity is required to produce uniform depletion. We developed an analytical expression for a time-invariant distribution of electrode conductivity that achieves largely uniform charging. We also presented a piecewise constant function which approximates the behavior of this idealized distribution and captures most of its benefit. The reduction in localized electrolyte depletion achieved by the non-uniform electrode conductivity distribution results in faster charging. Using the porous electrode model applied to an example supercapacitor, we show that reductions in electrode conductivity do contribute to resistive loss, as expected, but this loss is largely counterbalanced by the decreased resistive loss in solution corresponding to depletion. A penalty in energy efficiency and response time is also paid during discharge for the reduced conductivity in the electrode. However, as discharge rate is decreased, this loss becomes negligibly small.

One potentially important phenomena that we do not consider in our model is conduction along the surface of the electrode matrix resulting from the high ionic concentration in the double layer. This effect has been shown to allow enhanced charging kinetics in porous electrodes. Such conduction can help ameliorate the effect of electrolyte depletion in the bulk solution by providing an alternative ionic conduction path. However, the surface conduction path must be continuous throughout the electrode to significantly improve charging kinetics, which may limit its effect in many electrodes such as those formed by compacted powders with poor contact between particles. Furthermore, systems storing charge via Faradaic reactions, such as battery electrodes, will not generally display enhanced surface conduction.

Here we modeled systems representative of supercapacitors for high rate energy storage, but this approach has broad application to many electrochemical systems. As an example, CDI systems are particularly susceptible to localized depletion effects. Improved uniformity of depletion can likely enhance throughput of these systems. Furthermore, improvement of depletion uniformity using electrode resistance tailoring may provide a mechanism to improve battery safety by preventing the high field conditions associated with dendrite growth.

1. Apparatus comprising:
a porous electrode;
a counter electrode;
an electrolyte medium disposed to infiltrate pores of the porous electrode and to fill a separation between the porous electrode and the counter electrode;
wherein the electrolyte is configured to conduct electric charge primarily by electromigration of ions;
wherein the porous electrode is configured to store and release the ions;
wherein the porous electrode is configured to conduct electric charge primarily by migration of electrons or holes;
wherein an effective electrode conductivity of the porous electrode is less than an effective ion conductivity of the porous electrode in part or all of the porous electrode.

2. The apparatus of claim 1, wherein the porous electrode is configured to store and release the ions via double layer capacitance.

3. The apparatus of claim 1, wherein the porous electrode is configured to store and release the ions via electrochemical reactions.

4. The apparatus of claim 1, wherein at least 10% by volume of the porous electrode has a lower effective electrode conductivity than effective ion conductivity.

5. The apparatus of claim 4, wherein at least 40% by volume of the porous electrode has a lower effective electrode conductivity than effective ion conductivity.

6. The apparatus of claim 1, wherein the effective electrode conductivity of the porous electrode increases as distance from the counter electrode increases.

7. The apparatus of claim 1, further comprising at least one rectifier connected in parallel with the porous electrode.

8. The apparatus of claim 1, wherein the porous electrode is formed from a mixture of powdered constituents.

9. The apparatus of claim 1, wherein the effective electrode conductivity of the porous electrode is configured to improve uniformity of stored charge in the porous electrode.

10. The apparatus of claim 1, wherein the effective electrode conductivity of the porous electrode is configured to improve uniformity of concentration of ions in solution in the electrolyte within the porous electrode.

11. The apparatus of claim 1, wherein the effective electrode conductivity of the porous electrode is configured to enhance concentration of ions in solution in the electrolyte at locations inside the porous electrode near the counter electrode during charging of the apparatus.
